(19) United States
(12) Patent Application Publication
(10) Pub. No.: US 2012/0124550 A1
(43) Pub. Date: May 17, 2012

(54) FACILITATING DATABASE APPLICATION CODE TRANSLATION FROM A FIRST APPLICATION LANGUAGE TO A SECOND APPLICATION LANGUAGE

(76) Inventors: Robert Nocera, Glastonbury, CT (US); Ernst Renner, Tolland, CT (US)

(21) Appl. No.: 11/676,950

(22) Filed: Feb. 20, 2007

Related U.S. Application Data
(60) Provisional application No. 60/775,852, filed on Feb. 22, 2006.

(51) Int. Cl. G06F 9/44

(52) U.S. Cl. 717/104

(57) ABSTRACT

A method of facilitating code translation from one a first application language to a second application language is provided. This method involves reading information describing the database to a code generation engine and reading database applications associated with the first application language to the code generation engine. The code generation engine may use extractors to generate a database Meta model associated with the first application language and a source database application Meta model associated with the source database application. The code generation engine may then generate second database application code using a code generation engine that applies constructors to the source database application Meta model.

### RELATED APPLICATIONS

This application claims priority to and incorporates by reference in its entirety for all purposes U.S. Provisional Application No. 60/775,852 filed on 22 Feb. 2006 entitled “SOFTWARE FOR CONVERTING AN APPLICATION FROM ONE PLATFORM TO ANOTHER.”

### TECHNICAL FIELD OF THE INVENTION

The present invention relates generally to databases and more particularly to database applications that operate on databases.

### BACKGROUND OF THE INVENTION

A database is a collection of records or information stored within a computer in a structured way, so that a computer program (software application or set of instructions) can query the database to retrieve the appropriate information in response to the queries. Information retrieved in response to queries can be used to make decisions. The computer program used to manage and query a database is known as a database management system (DBMS).

Typically, for a given database, there is a structural description of the type of information held within: this description is known as a schema or database model. This schema describes the information objects represented in the database and their relationships. There are a number of different ways of organizing a schema or application language (or data models). The model in most common use today is the relational model. This model represents relationships by the use of common values. Other models such as the hierarchical model and the network model use a more explicit representation of relationships. Database management systems (DBMS) are usually categorized according to the supported data model (i.e. relational, object-relational, network, etc.). The data model may determine the query languages available to access the database.

The Internet and other forms of networks allow databases to be shared such that database applications can operate on these common or shared databases. For example, a client application located on an individual computer may act upon a shared database available through a network connection such as the Internet. This allows increased access to information. New architectures and application languages such as Java allow database applications previously written as client server applications to be written as browser-based web enabled applications which accessed a remote database via the Internet or other network connection. This web based type of database application allows the application to be standardized across an enterprise and updated as the database application may be executed within a browser.

Many companies have invested significant resources in developing unique database applications which are particular to a given application language. For example, many database applications have been written using Oracle's Oracle Forms software as the application language. This product is commercially available from Oracle Corporation, Redwood Shores, Calif. These database applications allow specific functions to be performed on the database. However, as new application languages are utilized, the database applications must be translated for the new application languages. These database applications that initially required a great deal of development, must now be individually updated. The cost of this update has often forced database users to use unsupported legacy versions of specific application languages rather than updating the database application to a more capable application language. Therefore, an efficient method with which to improve or update the database application is required.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWING

For a more complete understanding of the present invention and the advantages thereof, reference is now made to the following description taken in conjunction with the accompanying drawings in which like reference numerals indicate like features and wherein:

FIG. 1A provides a functional diagram that describes the processes used by embodiments of the present invention to facilitate code translation from a first application language to a second application language;

FIG. 1D provides a functional diagram similar to that of FIG. 1A that describes the processes used by embodiments of the present invention to facilitate code translation from a first application language to a second application language wherein particulars are assigned to the application languages used;

FIG. 2 provides another functional block diagram illustrating the processes associated with translating an existing database application to produce source code for a database application based on a second application language;

FIG. 3 shows how an Oracle Form (database application within a specific application language) may be processed using embodiments of the present invention;

FIG. 4 depicts the development or translation of a database object from a first application language to a second application language in accordance with embodiments of the present invention;

FIG. 5 depicts in further detail the use of Meta models and constructors to produce generated code in accordance with embodiments of the present invention;

FIG. 6 provides an embodiment of the present invention wherein Oracle Forms operating on the Oracle database are processed in accordance with embodiment to the present invention to produce JSF applications; and

FIG. 7 provides a logic flow diagram describing the process of code translation from a first application language to a second application language in accordance with embodiments of the present invention.

### DETAILED DESCRIPTION OF THE INVENTION

Preferred embodiments of the present invention are illustrated in the FIGUREs, like numerals being used to refer to like and corresponding parts of the various drawings.

The process of updating customized interfaces for databases (i.e. database applications) merely to support new or improved versions of application languages may be a very complex and costly endeavor with negative impact on organizational readiness. Embodiments of the present invention provide methods or tools to accelerate the translation of database interfaces such as those provided by Oracle Forms into an updated language such as Java. These tools reduce cost and development time, improve flexibility and organizational readiness.

Existing database applications are written within a specific application language. The arrival of many new or different application languages may allow existing database applications to realize additional functionality associated with these application languages. Embodiments of the present invention facilitate the process of reproducing existing database applications that may operate in these different application languages. Facilitating this process improves organizational readiness and reduces both engineering time, development costs and risk associated to database application language de-support.

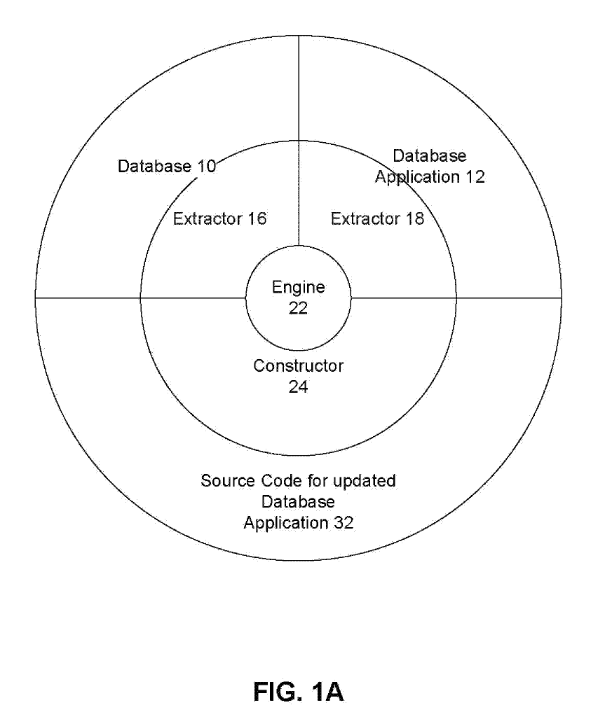

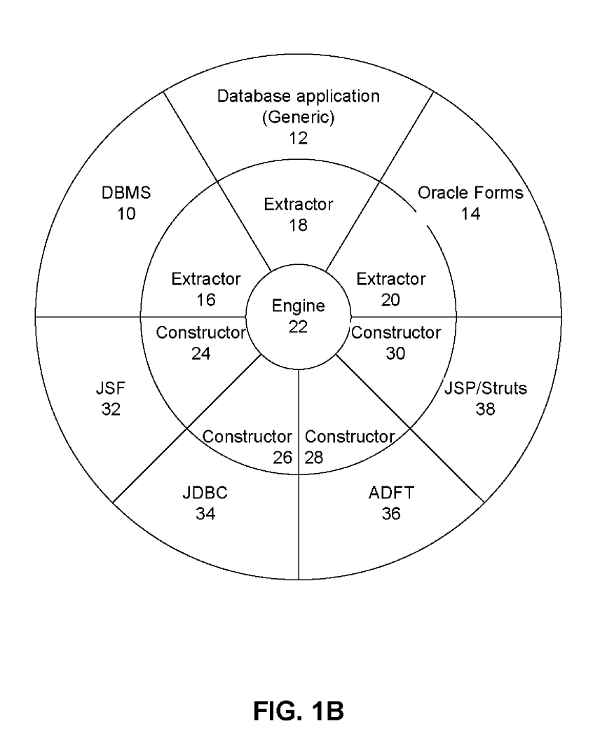

FIG. 1A provides a functional diagram describing the processes used by embodiments of the present invention to facilitate code translation from a first application language to a second application language. This functional diagram includes database management systems (DBMS) (i.e. database 10), database application 12, Extractors 16 and 18, code generation software engine 22, Constructor 24, and output code 32. Extractor 16 reads information associated with the database 10. This may include information such as, but not limited to, field names, views, tables, etc. Extractor 18 may be used to read information from a particular database application 12. Information from database 10 and database application 12 is read by extractor 16 and 18 respectively and used to build Meta models of the database (referred to as a MetaData Model) and database application (referred to as a MetaApplication Model) with code generation software engine 22. Code generation software engine 22 may then take the MetaApplication model of a database application 12 and the database MetaData model to create new source code 32 for database applications in a second application language.

FIG. 1B provides a functional diagram similar to that of FIG. 1A that describes the processes used by embodiments of the present invention to facilitate code translation from a first application language to a second application language wherein particulars are assigned to the application languages used. This functional diagram includes relational database management systems (database 10), database applications 12 and 14 such as, but not limited to Oracle Forms and Powerbuilder database application languages. Extractors 16, 18 and 20, code generation software engine 22 extractors 24, 26, 28, and 30, and output code 32, 34, 36 and 38. In operation, embodiments of the present invention use Extractor 16 to read information associated with the application language of DBMS 10. This may include information such as, but not limited to, field names, tables, etc. Extractor 18 may be used to read information from a particular database application 12 such as an Oracle Form. Extractor 20 may be used to read other information from other types of database applications such as Database application 14.

Information from DBMS 10, Database application 12 and Database application 14 is read by Extractor 16, 18 and 20 respectively and used to build MetaApplication models with the code generation software engine 22. The code generation software engine 22 may then take the MetaApplication model of a database application such as Database application 12 and the database MetaData model to create new database applications in a second application language. For example, Constructor 24 may be applied to the MetaApplication model by code generation software engine 22 in order to generate code representative of a source database application in a second database application wherein the second database application may comply with, but is not limited to, various Java-based frameworks including JSF, ADF, ADF, and Struts.

The code generation Software described above includes a collection of “Extractors” which plug into the Code generation Engine and Code generation User Interface. Extractors are used to load information from various sources including databases and application source code. Other sources such as Extensible Markup Language (XML) descriptions of applications or web service definitions are addressed by other Extractors. Each Extractor loads the information into an “Extractor Model”. The Extractor Model for a given Extractor is an in-memory definition of the source. It contains the information that describes the given source object. The MetaData Model and MetaApplication Model are both examples of Extractor produced Models.

“Constructors” are used by the Code generation Software to define how to generate the desired source code. A Constructor consists of a list of Tasks, software needed by those Tasks, and options for those Tasks that must have values supplied by the user through the UI. Tasks typically contain a template that is used by the engine when executing the Task definition fields, Definition Fields to define which part of the Extractor Model that Task should be used for, and where the generated file(s) should be written.

A code generation user interface (UI) may be used that allows a user to select the Extractors and Constructors that are run. The code generation user interface can be utilized to fine-tune the migration by reducing the amount of redundant code and allowing the user to specify the destination of portions of the code. The code generation user interface may also allow user specified customization so that the migrated application (generated source code) can accommodate specified frameworks or libraries that are not used in the original version of the Constructor supplied.

After the Extractor has created an Extractor Model, the user may view and/or modify the information that has been loaded by an Extractor. The user may also provide additional information to the model that may not have been defined in the existing source object, but may be useful in the generation of source code on a new platform. For example, this may be information about how to group business logic in the generated source code or information on what UI controls the generated source code may reference. The Code generation UI may also be used to modify existing Constructors or create new Constructors.

Constructors 24, 26, 28, and 30 are abstractions of the second application language in the form of Tasks and Templates that allow the code generation software engine 22 to operate on the first meta model produced by Extractors 16, 18 and 20 to produce code that may be used within a second application language. The generated code, such as that described by, but not limited to, JSF 32, JDBC 34, ADFT 36, and JSP/STRUTS 38 may then be examined by an engineer to ensure that the generated code operates as the original database application did in the original operating environment. In one embodiment JSF 32 is the “Presentation Layer” and the JDBC 34 is the “Persistence Layer.” JSF 32 builds what the user views and JDBC 34 builds the code that interacts with the database to save and retrieve data. This highly automates the process of translating a database application from a first application language to a second application language. This may only require certain quality checks and potential minor changes to the code produced by the Constructors prior to the release of the code as a new database application.

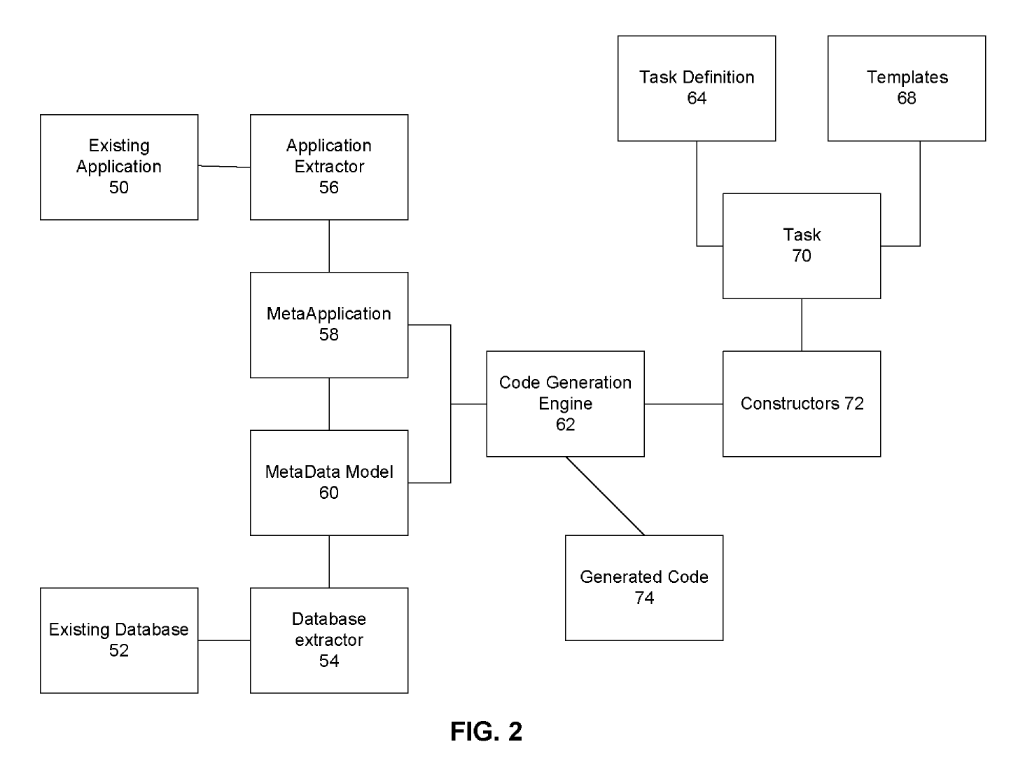

FIG. 2 provides another functional block diagram to illustrate the processes associated with translating an existing database application to produce source code for a database application within a second application language. Here an existing application 50 and existing database 52 may be operated on by application Extractor 56 and database Extractor 54. These Extractors operate on an existing application 50 and database 52 to produce an application model or MetaApplication model 58 and database MetaData model 60. As stated above, a user interface may be used that allows the user to fine tune the migration. These Meta models are provided to a code generation engine 62. The code generation engine 62 will provide information through a selected Constructor about the second application language for which the database application is to be translated. Task definitions 64 and templates 68 may form a task 70. One Task Definition 64 is associated with one Template 68 and both are associated with one task 70. Constructor consists of a group of tasks 70. Constructor 72 may be a specific Constructor associated with a specific second application language consisting of a library of tasks 70. As stated above for the Extractors, a user interface may be used that allows the user to fine tune the migration by reducing the amount of redundant code and allowing the user to specify the destination of portions of the code. The user interface allows the migrated application to be customized for the user to use proprietary frameworks or libraries.

This application language may be Java Service Faces (JSF), application development framework (ADF), RDFT, JSP/STRUTS, Microsoft.net, or other like frameworks or application programming, scripting, development or design languages. Additionally, this methodology can be used to facilitate the update of database applications from one version of an application language to a second version of an application language. This helps facilitate migration from a legacy version to a newer version or from a newer version to a legacy version, depending on what the user's requirements are. The code generation engine 62 will use Constructor 72 and the application model 58 and application language 60 to generate source code 74 which is the output that may be verified for functionality prior to implementation.

Additionally, this methodology can be used to facilitate the migration of database platforms and data from one type of database platform language to a second version of database platform.

These Constructors may be customized to specific frameworks or programming standards. For example, a specific error-handling framework may be desired by an end user. The specific error-handling framework can be referenced by the Constructors to ensure that all portions of the applications generated would use the same error-handling framework.

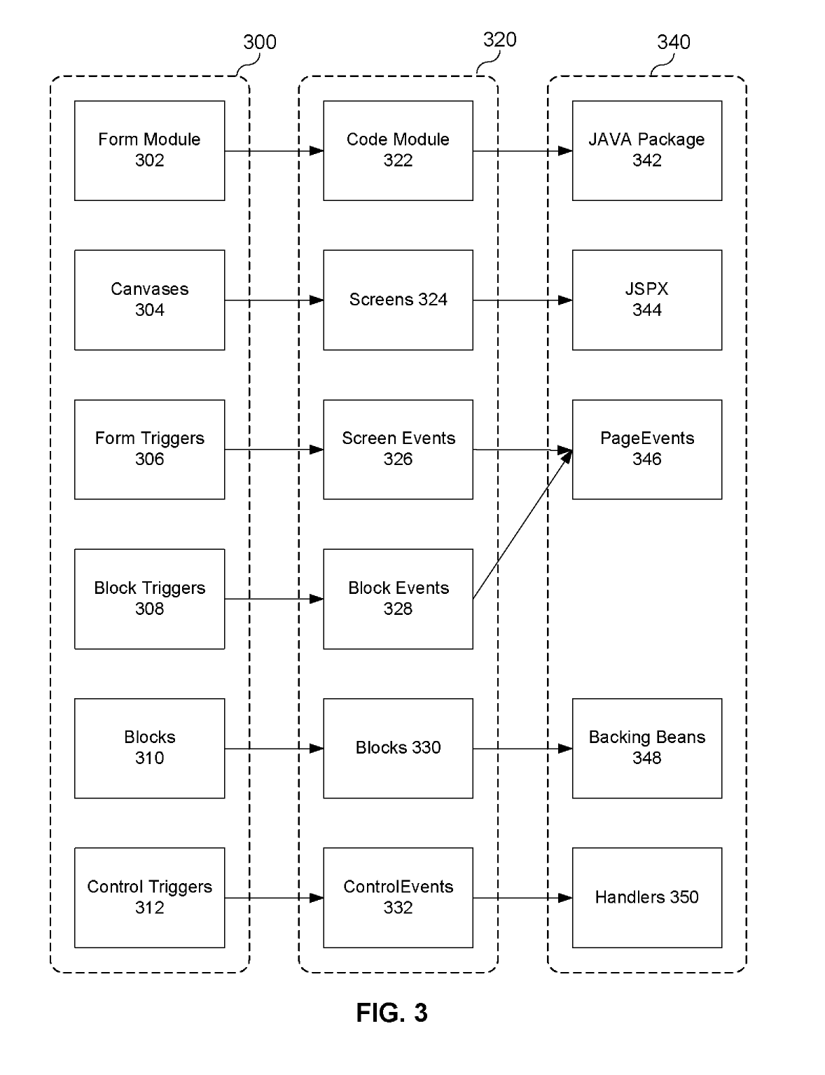

FIG. 3 shows how an Oracle Form 300 may be processed using embodiments of the present invention. Oracle Forms access Oracle database(s) and present data contained therein. An Oracle Form may include various components such as a form module 302, canvases 304, form triggers 306, block triggers 308 blocks 310, and control triggers 312. The Oracle Form 300 is used to produce a Meta model 320 which again may include various components such as code module 322, screens 324, screen events 326, block events 328, block 330, and control events 332. This meta model is in memory and used by the code generation software and Constructors to produce generated code 340 which in this case, but is not limited to, may be a JSF application that includes a Java package 342, JSPX 344, PageEvents 346, backing beams 348, and handlers 350. This generated code 340 may be tested and examined in order to determine if it meets certain quality and functional standards. If it does, then this may be implemented as a new database application which has been transformed or evolved from a client-server, database application, Oracle Form into a Java-based web-enabled application.

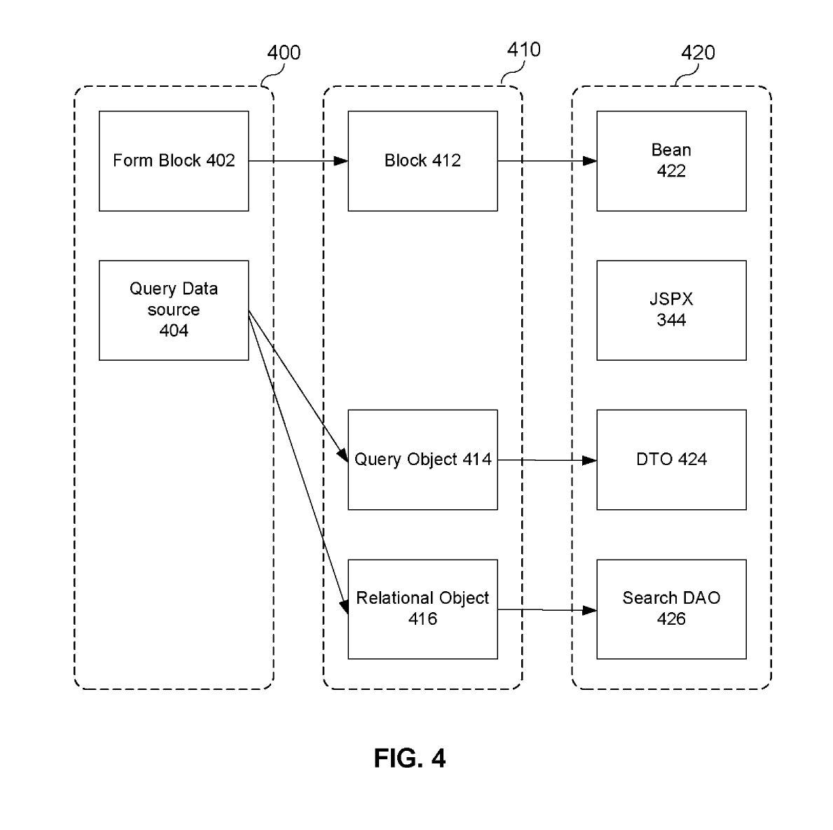

FIG. 4 depicts the development or translation of a database object from a first application language to a second application language. Here a source application object 400 may include a form block 402 and associated query data source 404. This application object 400 is used to generate a MetaApplication model 410 which includes a block 412, and a MetaData model which includes a query object 414 and a relational object 416. From this a second application object 420 may be produced which includes bean 422, DTO 424 and search DAO 426. Thus an application object may have been translated from one based on Oracle Forms into a Java standard object 420.

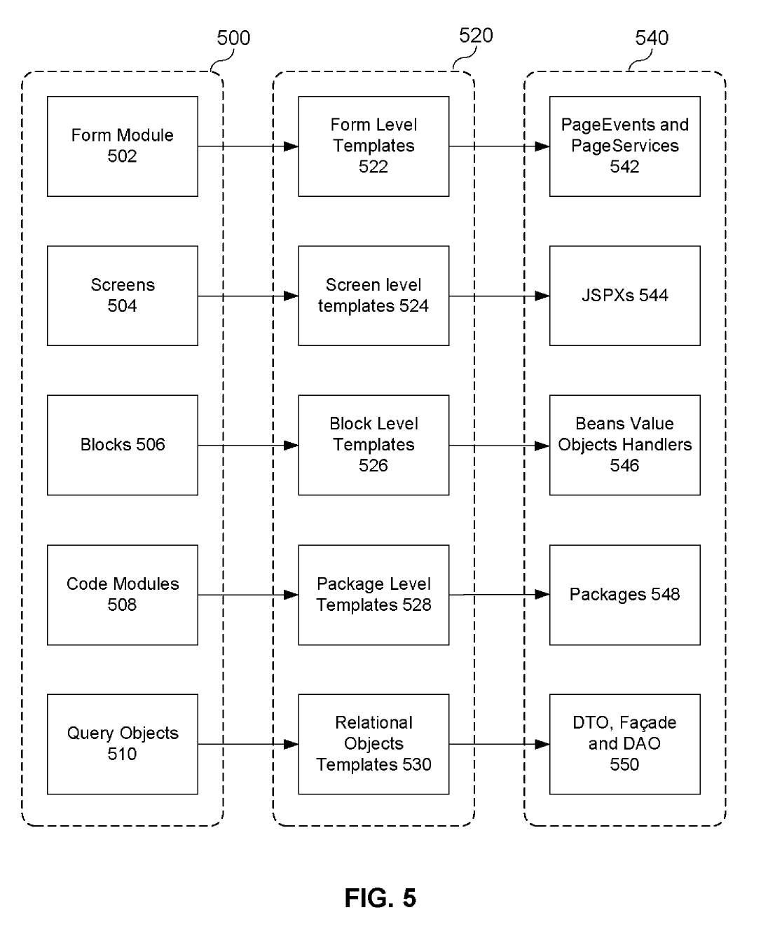

FIG. 5 depicts in further detail the use of Meta models and Constructors to produce generated code in accordance with embodiments of the present invention. Meta models 500, which may include a form module 502, screens 504, blocks 506, code modules 508, a query objects 510, may each be operated on by Constructors 520 to produce generated code 540. Constructors 520 may include form level templates 522, screen level templates 524, block level templates 526, package level templates 528, and relational object templates 530. The constructors as previously stated may be specific to a second application language and are applied by the code generation software to the Meta model in order to produce generated code 540. Additionally, these Constructors may be user-extendable so that the migrated application can be customized for the user, i.e., customized to use proprietary frameworks or libraries. As shown here, code 540 may include Page Events 542, JSPXS 544, beams value object handlers 546, packages 548, and DTOs, Facades, and DAOs 550.

Embodiments of the present invention result in significant time savings. For example, 50 percent of overall project time may be reduced by eliminating the need to design and develop new database applications using traditional, existing, methods. This will result in a cost savings. Depending on the application language used, it may be possible to also consolidate and reuse redundant code. This helps to ensure that the code provided is readable, maintainable, consistently written, and standardized while still allowing the ability to customize the output based on the end user's needs.

This also addresses the situation where database applications provided by third party vendors and written on legacy application languages are no longer supported or may not be available for purchase. The end user is therefore not able to support or extend their customized database application.

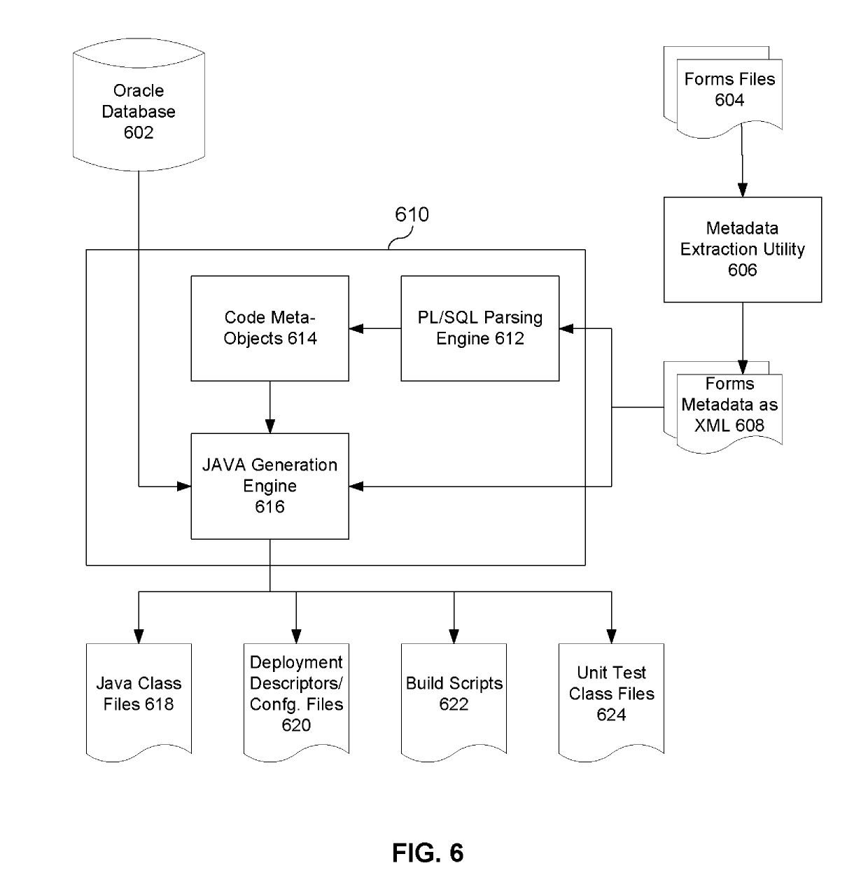

FIG. 6 provides an embodiment of the present invention wherein Oracle Forms operating on the Oracle database are processed in accordance with embodiments of the present invention to produce JSF applications. Here, an Oracle database 602 that may be described using various tables, views, procedures and metadata is made available to code generation software 610. Also, Form files 604 which are a specific database application that operate on Oracle database 602 are processed using a metadata extraction utility 606 in order to reproduce Forms 604 as an XML MetaApplication model 608. The code generation software may include a parsing engine 612 that operates on the XML metadata model 608 to produce meta-objects 614, and a Java generation engine 616. The Java generation engine will receive the inputs from the Oracle database, the Meta objects 614, and the database application model as an XML construct. Then the Java generation engine 616 will produce Java code, which may include, but is not limited to, Java class files 618, deployment descriptor/configuration file 620, build scripts 622, and Unit Test Class Files 624.

Specific embodiments of the present invention provide the ability to take client/server database applications such as those supported by Microsoft, Oracle, or other application frameworks known to those skilled in the art and facilitate development of other forms of database applications such as, but not limited to, Java based web-enabled applications.

Embodiments of the present invention provide a method and apparatus of loading the source code for an existing application or existing application component in one programming language or platform into an in-memory object model that describes the given application and subsequently using that object model to generate source code to replicate that application in another programming language or platform.

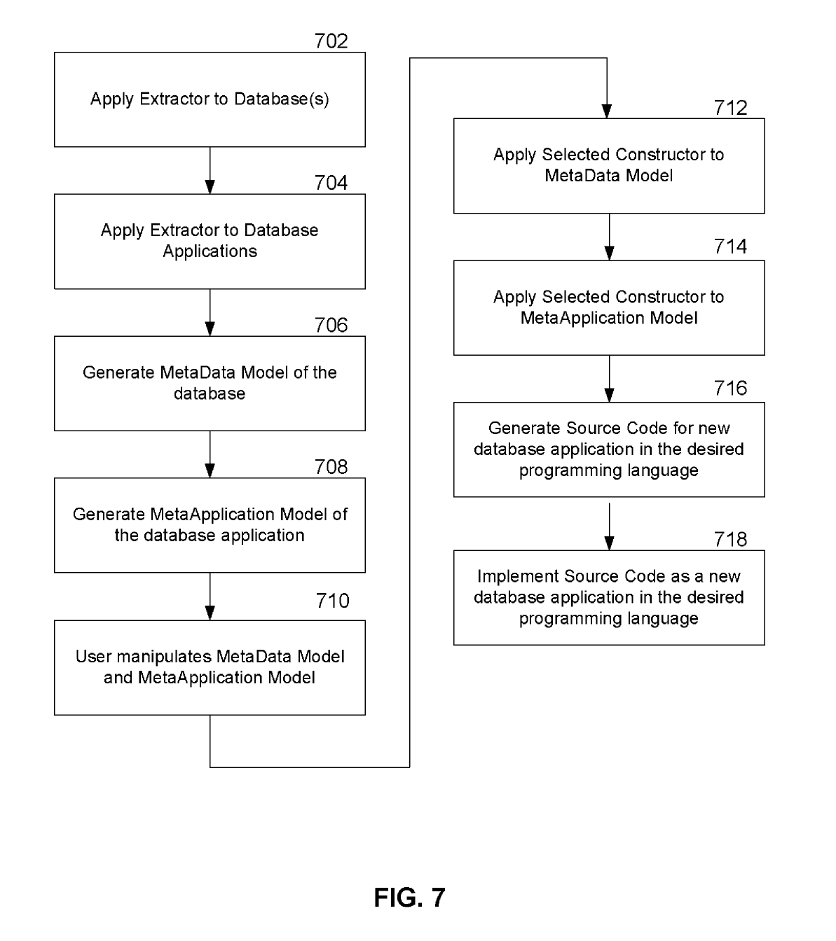

FIG. 7 provides a logic flow diagram describing the process of code translation from a first application language to a second application language in accordance with embodiments of the present invention. In step 702 Database Metadata Extractors connect to the database and extract information about that database for a Code Generation Metadata Model. The Code Generation Metadata Model may be used by the Code Generation Engine by itself or it may be combined with a Code Generation Application Model, created by the Code Generation Application Extractor which was applied to an existing database application in Step 704. This allows the MetaData model of the database to be produced in step 706 and the MetaApplication model of the database application to be produced in step 708.

To apply the Code generation Application Extractor, the user uses a Code Generation User Interface to select text or XML file(s) that have the description of the application to be converted. These file(s) are loaded and transformed into an in-memory description of the application which is called the Code generation MetaApplication Model. When the model is created, a Code generation MetaData Model is also created that contains information on the pieces of the application that access the database. The Code generation MetaApplication Model contains all of the information in the original application files, but in a format that is useful to the Code generation Software Engine.

Utilizing the Code generation Software GUI in Step 710, the user of the software can modify aspects of the Code Generation MetaData and MetaApplication Models or any other Extractor Models that have been used. Modifying the MetaData Model and MetaApplication Models through the User Interface allows one to reduce redundant classes, group like elements, and specify destination locations for model elements. The User Interface also allows the user to modify the selected Constructors to generate code or files that are unique to the user and may utilize other frameworks or libraries unique to the user and not originally included in the original software package.

The user can change the business logic that was loaded. The user can choose to indicate the different layers of source code that a piece of the Code generation Application Model belongs to.

The MetaData models allow the Code Generation Engine to produce a more concise description of the way data is accessed from database(s) in the existing application.

After the user has modified the aspects of the Code generation MetaApplication Model and Code generation MetaData Model to their satisfaction, the user then chooses which Constructor to use to generate the source code. In Step 712 the selected Constructors are applied to the MetaData Model. Similarly, in Step 714 the selected Constructors are applied to the MetaApplication Model. The Code Generation Extractor Models can subsequently be used by various Constructors in Step 716 during source code generation performed by the Code Generation Engine to generate source code in the desired programming language.

Each Constructor consists of a list of tasks that are needed to generate the source code and some information about how they are used, for example, which template to use to generate the code, where the generated file is to be placed relative to the root directory, whether there should be one source file for the whole project, one for each form file being converted, or one for each Model level component. It also specifies which model level component is needed for each task in the project.

Constructors can be customized for each user by providing information to the Constructor through the use of defined Constructor options, changing the definition of the tasks in the Constructor and the modification of the templates actually used for the source code generation.

After the source code has been generated, the Code Generation Software is no longer needed for the generated application to be compiled and deployed to the desired platform. The source code can be implemented as a new application in Step 718 to access data stored in the database used by the existing application as well as execute any code in the given database used by the existing application.

In summary, embodiments of the present invention provide software that facilitates the migration of legacy database-driven applications to newer programming languages and architectures. One specific embodiment facilitates the migration of Oracle Forms applications to Java-based web applications. More generally, the present invention provides a method of facilitating code translation from one application language to a second application language. This method involves reading information describing the first database model to a code generation engine and reading database applications associated with the first application language to the code generation engine. The code generation engine may use Extractors to generate a database Meta model (a MetaData Model) and a source database application Meta model (a MetaApplication Model) associated with the source database application. The code generation engine may then generate a second database application using a code generation engine that applies Constructors to the source database application Meta model.

As one of average skill in the art will appreciate, the term “substantially” or “approximately”, as may be used herein, provides an industry-accepted tolerance to its corresponding term. As one of average skill in the art will further appreciate, the term “compares favorably”, as may be used herein, indicates that a comparison between two or more elements, items, etc., provides a desired relationship.

Although the present invention is described in detail, it should be understood that various changes, substitutions and alterations can be made hereto without departing from the spirit and scope of the invention as described by the appended claims.

What is claimed is:

1. A method of facilitating database application code translation from a first application language to a second application language comprising:
reading information describing the database to a code generation engine;
reading a source database application written in the first application language to the code generation engine;
generating a database meta model associated with the database;
generating a source database application meta model associated with the source database application; and
generating second database application code in the second application language using a code generation engine that applies Constructors to the source database application meta model.

2. The method of claim 1, further comprising evaluating functionality of the second database application code.

3. The method of claim 2, releasing the second database application code for use within a second database environment after a favorable evaluation.

4. The method of claim 1, wherein Extractors read the information describing the first database model and the database applications associated with the first application language to the code generation engine.

5. The method of claim 1, wherein the first application language is an Oracle application language.

6. The method of claim 1, wherein the second application language is a Java Service Faces (JSF) framework.

7. The method of claim 1, wherein the source database application is an Oracle Form.

8. A method of facilitating code translation from one a first application language to a second application language comprising:
applying Extractors to read information describing the source database to a code generation engine;
applying Extractors to database applications associated with the first application language to the code generation engine;
generating a source MetaData Model associated with the first application language;
generating a source MetaApplication Model associated with the source database application; and
selecting Constructors associated with a specific application language
applying the Constructors to the source MetaData Model and the source MetaApplication Model;
generating a second database application code in the second application language using a code generation engine.

9. The method of claim 8, further comprising evaluating functionality of the second database application code.

10. The method of claim 9, releasing the second database application code for use within a second database environment after a favorable evaluation.

11. The method of claim 8, wherein the first application language is an Oracle application language.

12. The method of claim 8, wherein the second application language is a Java Service Faces (JSF) framework.

13. The method of claim 8, wherein the source database application is an Oracle Form.

14. The method of claim 8, further comprising manipulating the MetaData Model and MetaApplication Model through a User Interface.

15. The method of claim 14, wherein the MetaData Model and MetaApplication Model are manipulated to reduce redundant classes, group like elements, and specify destination locations for model elements.

16. The method of claim 8, further comprising selecting Constructors through a User Interface.

17. The method of claim 16, wherein the User Interface allows a user to modify the selected Constructors to generate code of files that are unique to the user and may utilize frameworks or libraries unique to the user.

18. A method of facilitating code translation from Oracle Forms application language to a second application language comprising:
applying Extractors to read information describing a source database to a code generation engine;
applying Extractors to database applications associated with the Oracle Forms application language to the code generation engine;
generating a source MetaData Model associated with the Oracle Forms application language;
generating a source MetaApplication Model associated with the Oracle Forms database application; and
selecting Constructors associated with a specific application language
applying the Constructors to the source MetaData Model and the Oracle Forms database application meta model;
generating second database application code in the second application language using a code generation engine;
evaluating functionality of the second database application code; and
releasing the second database application code for use within a second database environment after a favorable evaluation.

19. The method of claim 18, wherein the second application language is a Java Service Faces (JSF) framework.
